(19) United States
(12) Patent Application Publication
(10) Pub. No.: US 2025/0047401 A1
(43) Pub. Date: Feb. 6, 2025

(54) Connector for Integration of Ethernet Time Synchronization Stacks

(71) Applicant: NXP USA, Inc., Austin, TX (US)

(72) Inventors: Alexandru Marginean, Meilen (CH); Jaroslav Necesany, Roznov pod Radhostem (CZ); Ludovit Minarik, Konska (CZ); Ondrej Spacek, Prerov (CZ); Dragos-Mihai Morarescu, Mogosoaia (RO); Martin Gazda, Novy Jicin (CZ)

(21) Appl. No.: 18/768,829

(22) Filed: Jul. 10, 2024

(30) Foreign Application Priority Data
Aug. 3, 2023 (RO) 202300427

(51) Int. Cl. H04J 3/06; H04L 12/46

(52) U.S. Cl. CPC H04J 3/065; H04L 12/4641

(57) ABSTRACT

A time synchronization system, method, apparatus, and architecture are provided for synchronizing timing between two different time synchronization stacks with a timing synchronization connector which receives a frame transmit request at a first virtual Ethernet controller from a first time synchronization stack, which generates at a virtual timestamp module a sampled timestamp value for the frame by sampling a hardware counter, which forwards the sampled timestamp value for the frame over a second virtual Ethernet controller along with the frame to a second time synchronization stack, and which sends the sampled timestamp value for the frame to the first time synchronization stack, where the first and second time synchronization stacks each use the sampled timestamp value to compute a time synchronized Precision Time Protocol (PTP) clock domain signal.

### BACKGROUND

### Field of the Invention

The present disclosure is directed in general to synchronization module and associated methods of operation. In one aspect, the present disclosure relates to time synchronization software stacks in networked systems.

### Description of the Related Art

Modern automobiles include various electronic control units (ECUs) that implement, for example, engine control, power train control, airbag systems, antilock brake systems, cruise control, electric power steering, audio systems, window control systems, door control systems, mirror adjustment systems, and battery and recharging systems for hybrid/electric cars. The ECUs communicate with each other in an automobile via in-vehicle network (IVN) technologies, such as Ethernet, but conventional IEEE standards for Ethernet switching (e.g., IEEE 802.1Q) are ill-suited for use cases, such as audio and video streaming over Ethernet, and are even less suited for control-type applications based on Ethernet. To satisfy the more stringent requirements for audio and video streaming, a set of IEEE 802.1 Audio Video Bridging (AVB) and Time Sensitive Networking (TSN) standards have been developed which extend the features of IEEE 802.1Q to satisfy the more stringent requirements. For example, IEEE 802.1AS provides a standard (e.g., generalized Precision Time Protocol (gPTP)) for distributed synchronization needed to support synchronized packet processing. While the gPTP standard has been enhanced to support multiple clock domains, the standard does not define the implementation details. In addition, some of the practical implementations, such as those used in automotive applications, have conflicting requirements that are not addressed by a single time sync stack. In general, these standards do not govern the actual implementations, and the conflicting requirements problem has more to do with the implementation rather than being a problem of the standard. For example, automotive systems that integrate an Ethernet switch must be able to integrate a standardized time synchronization stack which supports existing time aware applications, but existing standardized time synchronization stacks used in automotive applications are not designed to support bridging of time synchronization traffic, which is a common feature of Ethernet switch time synchronization stacks.

Existing time synchronization solutions fail to efficiently solve the problem of such conflicting requirements. For example, a common implementation is a gPTP singe step solution which implements a gPTP stack software component running over an Eth interface by including a hardware-implemented timestamping module which generates time stamps that are inserted into transmitted synchronization message frames for communication over Ethernet wires. Another common implementation is a two-step PTP solution which uses sync and follow-up frames exchanged by multiple devices over a physical Ethernet network to implement a time synchronization architecture. As seen from the foregoing, the existing time synchronization solutions are extremely difficult at a practical level by virtue of the challenges with satisfying conflicting requirements that arise from different synchronization stacks contained in networked communication systems.

### BRIEF DESCRIPTION OF THE DRAWINGS

The present invention may be understood, and its numerous objects, features and advantages obtained, when the following detailed description of a preferred embodiment is considered in conjunction with the following drawings.

FIG. 1 is a block diagram of a communication system wherein a time sync connector provides an interface between different time sync stacks using virtual Ethernet controllers and virtual time stamping of frames based on time information from a hardware timer in accordance with selected embodiments of the present disclosure.

FIG. 2 illustrates the transmission of sync and follow-up messages from a grandmaster to bridges and to an end station.

FIG. 3 is a simplified timing diagram illustrating timing synchronization with a conventional process flow for synchronizing two networked devices connected by wire connectors using hardware timestamping.

FIG. 4 is a simplified timing diagram illustrating timing synchronization with a conventional process flow for synchronizing two networked devices connected by wire connectors using software timestamping.

FIG. 5 is a simplified timing diagram illustrating timing synchronization with a timing sync connector for synchronizing two time synchronization stacks using software timestamp sampling of a hardware timer in accordance with selected embodiments of the present disclosure.

FIG. 6 depicts a simplified flow chart showing the logic for using a timing sync connector to forward traffic between the time synchronization stacks in accordance with selected embodiments of the present disclosure.

FIG. 7 depicts a block diagram of a cross-channel safety analysis system for using redundant model predictive controllers to perform cross channel safety analysis in accordance with selected embodiments of the present disclosure.

### DETAILED DESCRIPTION

A software-based timing synchronization connection method, device, system, and program code are described for integrated interoperation of different Ethernet time synchronization stacks at a networked communication system. In selected embodiments, timing synchronization between different time sync stacks may be implemented by configuring a time sync connector module with virtual Ethernet controllers which provide generic interfaces to the different time sync stacks, thereby abstracting the time sync connector module from the specific implementations of the different time sync stacks. In addition, the time sync connector module is configured with a virtual timestamp module which is connected to receive time information from a hardware timer or free-running counter for use in generating timestamping information for received and transmitted Ethernet time synch frames. With the disclosed timing synchronization connection scheme, standardized time sync stacks and bridging time sync stack may be interoperably integrated by using software-based, virtual Ethernet links between software components in combination with timestamping on the virtual Ethernet links in a way that allows accurate time synchronization between parties. Compared to existing approaches for supporting timing synchronization between standardized and bridging time sync stacks, the disclosed timing synchronization connection scheme does not entail technically complex and expensive solutions that require new specifications or implementations from third parties, thereby providing an efficient synchronization solution within a development time-frame that is suitable for systems in development today.

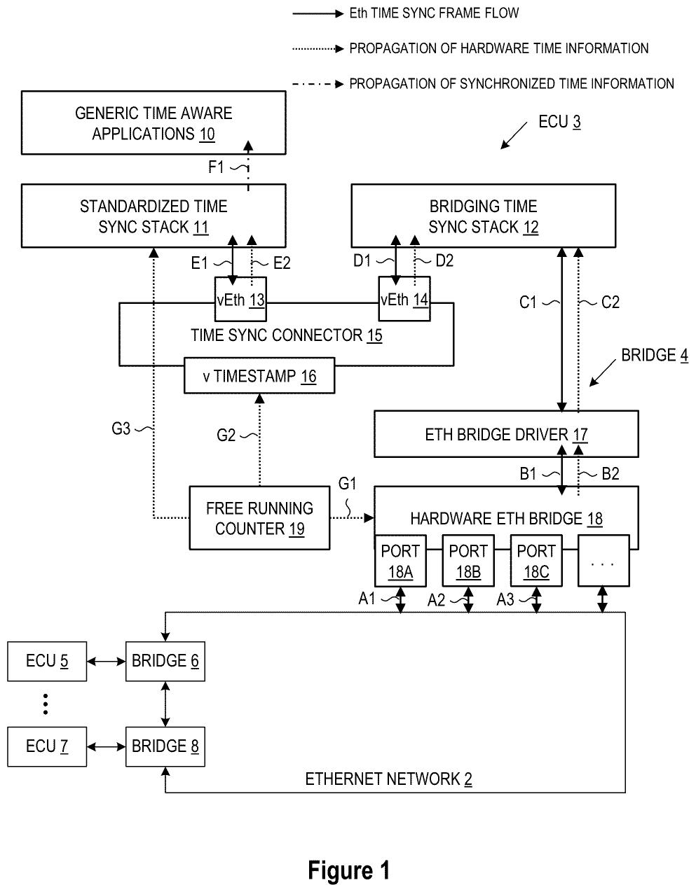

To provide additional details for an improved understanding of selected embodiments of the present disclosure, reference is now made to FIG. 1 which depicts a block diagram of a communication system 1, such as an in-vehicle network (IVN), that is configured to use, for example, IEEE 802.1AS (e.g., gPTP), to enable distributed clock synchronization amongst one or more end station nodes which are connected or networked together over bridges to form an Ethernet network 2. As disclosed, the end station nodes may include, for example, various electronic control units (ECUs) 3, 5, 7, such as an engine control module (ECM), a power train control module (PCM), airbags, antilock brakes, cruise control, electric power steering, audio systems, windows, doors, mirror adjustment, battery and recharging systems for hybrid/electric cars, and many more. In addition, each end station node (e.g., ECU 3) is connected over a corresponding bridge 4 (e.g., 17-18) to one or more different end station nodes (e.g., 5, 7) via corresponding bridges (e.g., 6, 8).

As will be appreciated, the communication system 1 may include one or more clock sources and various clock targets at the end station nodes. For example, the end station 7 may include a clock source (not shown) that is designated as the “grandmaster” or “GM” and the remaining end station nodes may include a clock target (not shown), where each clock source is used to establish one or more gPTP clock domains that are distributed throughout the Ethernet network 2 (taking separate paths for the best possible redundancy). In selected embodiments, the Ethernet network 2 may implement IEEE 802.1AS and gPTP clock domains, but the Ethernet network 2 could implement other Precision Time Protocols to support Time Sensitive Networking. The term “PTP” is used herein to refer to a Precision Time Protocol that may include, for example, the generalized Precision Time Protocol (gPTP). Although the Ethernet network 2 is shown as a ring or loop network, the network can have other configurations, such as hub and spoke. And while the Ethernet network 2 is shown as including bridges 4, 6, 8, the Ethernet network 2 may include other types of nodes, such as, for example, routers, switches, and/or multi-port end stations.

In order to maintain synchronization between the end station nodes and a grandmaster (GM), a synchronization operation is performed when the grandmaster periodically transmits synchronization (or “sync”) messages (e.g., via Ethernet frames) and follow-up messages (in case of two step operation) which the receiving bridges or end station nodes use to compute a local clock time based on information from the sync and follow-up messages and network propagation delay. The sync message works as a trigger for ingress and egress timestamp generation on both sides of the link. The follow-up message (in case of two step operation) carries time Precision origin timestamp representing Grand Master time and correction information representing how long the time information spent on the uplink nodes until transmitted from the last node. Delays over wire can be determined using path or peer delay mechanisms.

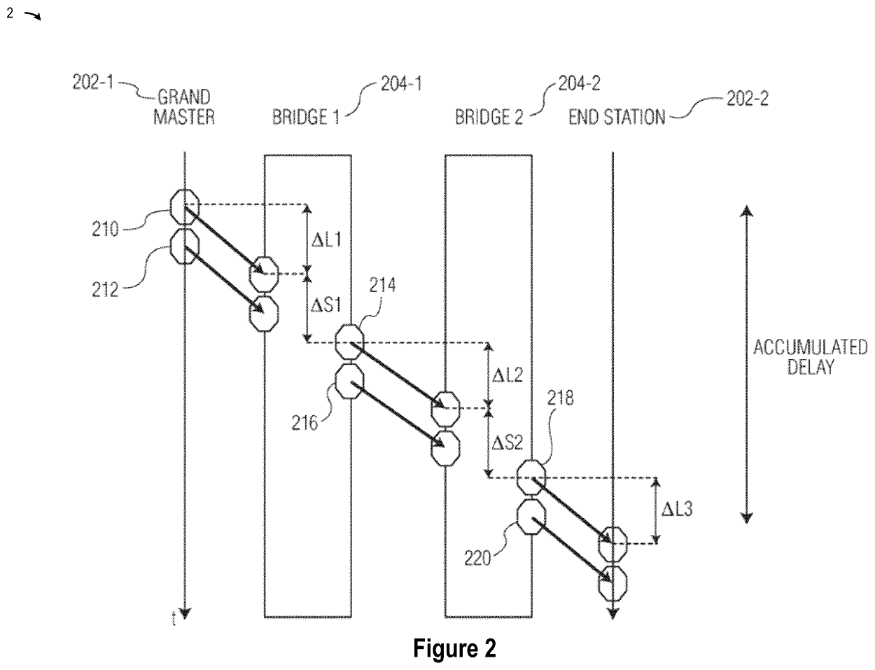

Turning now to FIG. 2, there is illustrated the transmission of sync and follow-up messages from a grandmaster 202-1 to bridges 204-1 and 204-2 and to an end station 202-2 in the Ethernet network 2. At time 210, a sync message carrying GM time information can be sent from the grandmaster 202-1 to bridge 1 204-1 (which has a wire propagation delay ΔL1), and at time 212, a follow-up message carrying GM time correction can subsequently be sent by the grandmaster 202-1 to the bridge 1 204-1. In turn, Bridge 1 204-1 can then compute a local clock time by adding the propagation delay between the grandmaster 202-1 and bridge 1 204-1 to the clock time, and at time 214, Bridge 1 204-1 can then forward the sync message to bridge 2 204-2 (which has a wire propagation delay ΔL2) and compute a residence time to transmit in a follow-up message at time 216 to bridge 2 204-2. The process can be repeated to send a sync message to the end station 202-2 at time 218 and a follow-up message to the end station 202-2 at time 220. The time correction to transmit in a follow-up message is the accumulated residence time and, in case of peer delay mechanism, the cumulated time on wire up to the current node. The network propagation delay can be computed from correction field of the follow-up message, residence time of a message within a node, propagation delay over wires. In order to determine propagation delay over the network between nodes, the nodes can periodically exchange timing-related messages and perform internal calculations based on the timing-related messages specified by the IEEE 802.1AS protocol, including a “Sync” message, a “Follow_Up” message, a “Pdelay_Req” message, and “Pdelay_Resp” and “Pdelay_Resp_Follow_Up” messages. For example, the residence time within a bridge is determined using ingress and egress timestamps of the received and transmitted “Sync” messages, while the wire propagation delay can be determined using the “Pdelay_Req,” “Pdelay_Resp,” and “Pdelay_Resp_Follow_Up” messages. Additional details regarding the synchronization information contained in the messages and how they are used to determine the propagation delay between end station nodes using either a single-step (which requires frame modification hardware) or two-step approach (which does not require frame modification hardware) will be known to persons skilled in the art who are familiar with the IEEE 802.1AS protocol, and will therefore not be repeated here.

As will be appreciated, each end station node 3, 5, 7 will need to run a time sync stack in order to synchronize local time to the grandmaster's time. However, the implementation of time synchronization in certain systems may encounter conflicting requirements that cannot be practically addressed with a single time synchronization stack. For example, automotive systems that integrate an Eth switch may include an operating system (e.g., AUTOSAR, etc.) that includes a standardized time synchronization stack to support other time-aware applications that need access to the synchronized time, but that does not include bridging support for the reception, processing, and/or forwarding of gPTP packets and applying time correction. Another deficiency with existing operating systems (such as AUTOSAR) is that they are not synchronizing hardware time. In addition, existing operating systems (such as AUTOSAR) are not equipped to support time synchronization on systems (such as System-on-Chip) where multiple operating systems are running and requiring access to the synchronized time. Yet another challenge with existing operating systems (such as AUTOSAR) are proprietary programs that cannot be modified by third parties.

To overcome these limitations from existing operating systems while also retaining the functionality of such systems, each end station node (e.g., ECU 3) may include two or more different Ethernet time synchronization software stacks which are integrated in different nodes and operate together. For example, the depicted ECU 3 includes a first standardized time sync stack 11 that can run the AUTOSAR OS in support of one or more generic time aware applications 10. However, to address functional limitations of the existing standardized time sync stacks 11, the ECU 3 also includes a bridging time sync stack 12 that is connected to an Ethernet bridge driver 17 and hardware Ethernet bridge 18 which communicates across multiple ports 18A-C to other end station nodes in the network. While bridging support could potentially be integrated in the standardized stack, there are significant technical barriers to such a solution, such as requiring new specifications and new implementations from third parties, that are not suitable for the time-frame of developing systems today. A more practical solution disclosed herein is to integrate an existing bridging stack 12 alongside a standardized stack 11 since these components exist and the time-frame for such a solution is much faster.

To provide an illustrative example of how to integrate an existing bridging stack (for implementing bridging gPTP packet processing and simulation of hardware time) alongside a standardized stack (for supporting existing time aware applications), the depicted ECU 3 includes a time sync connector 15 for connecting the standardized time sync stack 11 to the bridging time stack 12. Ordinarily, each of the standardized time sync stack 11 and bridging time sync stack 12 would be connected directly to the Ethernet network 2 using Ethernet controllers or interfaces, but instead, the time sync connector 15 is connected as an interface between the Ethernet network 2 and the standardized time sync stack 11 and bridging time sync stack 12. As depicted, the time sync connector 15 functions as a point-to-point virtual Ethernet by including a first and second virtual Ethernet controllers 13, 14 which are software constructs that appear to Ethernet interfaces to the stacks 11, 12 and that pass PTP frames between the stacks 11, 12 to achieve timing synchronization therebetween. To this end, the time sync connector 15 also includes a virtual timestamp module 16 to provide a common or shared understanding of time based on the input from the free running counter 19. The first virtual Ethernet controller 13 is connected to propagate hardware time information to the standardized time sync stack 11, and to exchange Ethernet time synch frame flows with the standardized time sync stack 11. In similar fashion, the second virtual Ethernet controller 14 is connected to propagate hardware time information with a software-based bridging port at the bridging time stack 12, and to exchange Ethernet time synch frame flows with the bridging time stack 12. Finally, the virtual time stamp module 16 is connected to receive hardware time information from the free running counter 19 and which is configured to timestamp frames passing through the time sync connector 15. To improve accuracy and reduce rounding errors, the free running counter 19 may be implemented as a hardware timer that is also connected to the standardized time sync stack 11 and to the hardware Ethernet bridge 18 for use in timestamping time sync traffic on bridge ports 18A-C.

In operation, the time sync connector 15 forwards any received frames from one virtual Ethernet controller 13 to the other virtual Ethernet controller 14, and vice versa. This would include IEEE 802.1AS timing-related messages, such as the “Announce”, “Signaling”, “Sync”, “Follow_Up”, “Pdelay_Req”, “Pdelay_Resp” and “Pdelay_Resp_Follow_Up” messages. In addition, the time sync connector 15 uses the virtual time stamp module 16 to timestamp each forwarded gPTP frame so that each stack 11, 12 perceives a hardware timing stamp being added to each frame, even though the timestamps are being added by a software-based virtual time stamp module 16. For example, a Sync message A1 received at the hardware port 18A would be forwarded by the hardware Ethernet bridge 18 as a message B1 to the Ethernet bridge driver 17, along with additional data B2 conveying hardware-based timing information G1 derived from the free-running counter 19. In turn, the Ethernet bridge driver 17 passes the message C1 which is propagated to the bridging time sync stack 12, along with additional data C2 conveying hardware-based timing information. In turn, the bridging time sync stack 12 forwards or generates a message D1 which is propagated through a software-based bridging port to the virtual Ethernet controller 14 of the time sync connector 15 where it is forwarded by the virtual Ethernet controller 13 as the message E1 to the standardized time sync stack 11 along with additional data E2 and D2 which conveys the timestamp information generated by the software-based virtual time stamp module 16. The time sync connector 15 samples the timestamp and delivers the timestamp to both virtual Ethernet controller 14 and virtual Ethernet controller 13 that provide both E2 and D2 messages. The time sync connector 15 ensures the E2 and D2 can be identified with E1 or D1 that initiated their generation. Based on the information conveyed in the message E1 and D2 and associated additional data E2, the standardized time sync stack 11 may compute the synchronized time which is propagated via message F1 to the time-aware applications 10.

As depicted, the time sync connector 15 simulates a fixed length wire with hardware-based timestamping on both ends by providing a generic interface between the time sync stacks 11, 12 with the virtual Ethernet controllers 13, 14 to thereby abstract the time sync connector 15 from the implementation of the stacks 11, 12 and to provide connective interface functions by implementing reception and transmission of Ethernet time sync frames and by conveying timestamp information for received/transmitted frames back to the corresponding stacks 11, 12. To enable the timestamping, the time sync connector 15 includes the virtual time stamp module 16 which is connected to receive hardware time information G2 from the free-running hardware counter 19 for use in generating the timestamp messages E2, D2. In addition, the standardized time sync stack 11 may be connected through the time sync connector 15 to read hardware time information G3 from the free running hardware counter 19 for use in timestamping. To improve accuracy and reduce rounding errors, the running hardware counter 19 is also connected to provide the timing information G1 to the hardware Ethernet bridge 18 for timestamping time sync traffic on the bridge ports 18A-C.

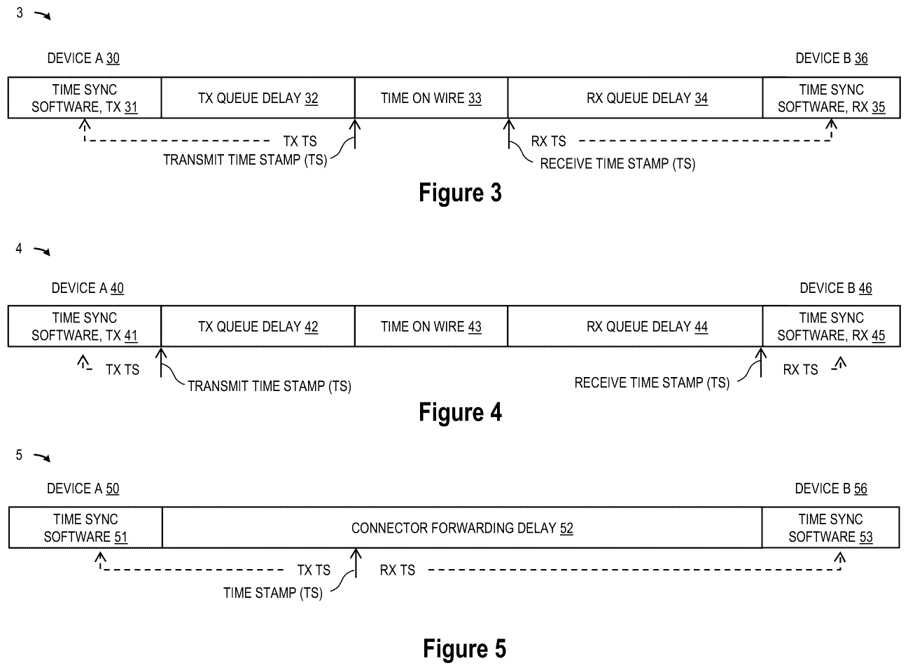

To provide additional details for a contextual understanding of selected embodiments of the present disclosure, reference is now made to FIG. 3 which depicts a simplified timing diagram 3 illustrating timing synchronization with a conventional process flow for synchronizing two networked devices 30, 36 connected by wire connectors using hardware timestamping. In this example, the first device A 30 (e.g., a grandmaster) may transmit a frame, such as a time sync message, at time period 31 which corresponds to the time required for software to transmit the frame. At the end of time period 31, the frame is loaded into the queue of the internal controller which is processing frames in the queue for transmission. During time period 32, the frame is held and/or processed in the transmit queue of the first device A 30 until such time as the first device A 30 starts transmitting the frame over the wire connectors. At this point, the transmit time stamp TS is sampled in hardware and sent back to the time sync software for the first device A 30 (e.g., for two-step processing). During time period 33, the frame is transmitted over the wire connectors until the second device B 36 begins receiving the frame during time period 34. At this point, the receive time stamp TS is sampled in hardware and sent to the time sync software for the second device B 36. And during time period 34, the received frame is held and/or processed in the receive queue of the second device B 36 until the time sync software at the second device B 36 begins processing the received frame during time period 35. In this example, the transmit and receive timestamps are provided by hardware for frames sent and received, and for accuracy reasons, these timestamps are collected as close to the wire as possible. The protocol converges on the assumption that time between timestamps/delay on a wire is fixed.

To provide additional details for a contextual understanding of selected embodiments of the present disclosure, reference is now made to FIG. 4 which depicts a simplified timing diagram 4 illustrating timing synchronization with a conventional process flow for synchronizing two networked devices 40, 46 connected by wire connectors using software timestamping when the underlying hardware does not support timestamping. In this example, the first device A 40 (e.g., a grandmaster) transmits a frame at time period 41 which corresponds to the time required for software to transmit the frame. At the end of time period 41, the transmit timestamp is sampled in software when the frame is loaded into the queue of the internal controller. During time period 42, the frame is held and/or processed in the transmit queue of the first device A 40 until such time as the first device A 40 starts transmitting the frame over the wire connectors. During time period 43, the frame is transmitted over the wire connectors until the second device B 46 begins receiving the frame during time period 44. When the frame is retrieved from the queue to begin receive processing at the second device B 46, the receive time stamp TS is sampled in software by the time sync software for the second device B 46. Since the transmit and receive timestamps are provided by the transmit and receive software without regard to queueing delays, time synchronization has relatively poor precision or accuracy because the path between timestamps has variable latency.

To provide additional details for an improved understanding of selected embodiments of the present disclosure, reference is now made to FIG. 5 which depicts a simplified timing diagram 5 illustrating timing synchronization with a timing sync connector for synchronizing two networked devices 50, 56 connected by wire connectors using software timestamp sampling of a hardware timer. In this example, the first device A 50 (e.g., a grandmaster) transmits a frame at time period 51 which corresponds to the time required for the time sync software at the first device 50 to transmit the frame. At the end of time period 51, the frame is transmitted to the timing sync connector which simulates a 0-delay wire link between stacks to avoid the accuracy shortcomings of the software-based timestamping. During time period 52, the frame is processed at the timing sync connector with a connector forwarding delay before being propagated to the second device B 56 for processing during the time sync software period 53. During processing in the time period 52, the timing sync connector performs software-based sampling of the timestamp from a hardware timer, and the resulting time stamp TS is propagated to the time sync software stacks in the first and the second devices 50, 56 as the transmit TS and receive TS, respectively. Since the software-sampled transmit and receive timestamp is provided to both the transmit and receive software by the timing sync connector which effectively simulates a fixed-length wire link, highly accurate time synchronization is achieved which avoids the shortcomings of software-based timestamping.

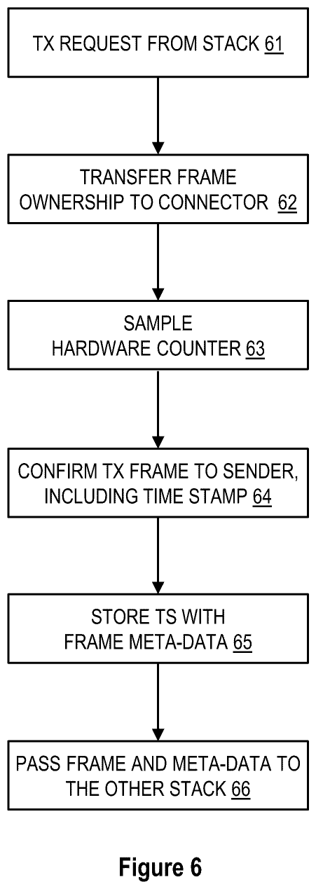

To provide additional details for an improved understanding of selected embodiments of the present disclosure, reference is now made to FIG. 6 which depicts a simplified flow chart 6 showing the logic for using a timing sync connector to forward traffic between the time synchronization stacks. In an example embodiment, the timing synchronization connection control logic and methodology shown in FIG. 6 may be implemented with hardware and/or software on an electronic control unit (ECU), microcontroller unit, or digital system processor that includes processor and memory for storing programming control code for controlling the operation of an automotive vehicle. As depicted, an embodiment of a method 6 for performing timing synchronization may include steps 61-66 shown in the general order of FIG. 6, though the method may include more or fewer steps or can arrange the order of the steps differently than those shown. Generally speaking, the disclosed method steps 61-66 are executed as a set of computer-executable instructions by a timing synchronization connector module or other computer system or processor and encoded or stored on a computer readable medium. In other configurations, the disclosed method steps 61-66 may be executed by a series of components, circuits, and gates created in a hardware device, such as a System of Chip (SOC), Application Specific Integrated Circuit (ASIC), and/or a Field Programmable Gate Array (FPGA). In other configurations, the method may be executed as an iterative loop where the processing steps 61-66 are periodically repeated on a predetermined schedule or on certain triggering events.

In the disclosed operational logic or control flow, a transmit request is received from a first timing synchronization stack at step 61. As disclosed herein, a timing synchronization connector module may be connected to receive a transmit request from either of the stacks (e.g., standardized time sync stack 11 or bridging time sync stack 12) which create an Eth time sync frame and call the transmit function of a first virtual Eth controller (e.g., vEth 13, 14) on the timing synchronization connector module.

At step 62, frame ownership is transferred to the timing sync connector. As disclosed herein, a timing synchronization connector module may take over the Eth frame, such as by transferring the frame to buffers owned by the timing synchronization connector module. However, depending on the applicable OS and network device specification, this step may be skipped.

At step 63, the hardware counter is sampled. As disclosed herein, the timing synchronization connector module may sample the current value of the hardware timer that is used to support timestamping for one or more timing synchronization stacks.

At step 64, a confirmation of frame transmission is sent to the first timing synchronization stack, along with the sampled timestamp value from step 63. As disclosed herein, a timing synchronization connector module may create a “transmit complete” notification which includes the sampled timestamp value, and then pass this information back to the first timing synchronization stack that initiated the frame transmission.

At step 65, the sampled timestamp value from step 63 is stored with the metadata for the frame being transmitted. As disclosed herein, a timing synchronization connector module may associate the sampled timestamp with the frame and propagate the frame forward for reception on a second virtual Eth controller of the timing synchronization connector module.

At step 66, the frame and associated metadata are passed to a second timing synchronization stack. As disclosed herein, a timing synchronization connector module may notify the receiving stack (e.g., bridging time sync stack 12) of Rx availability and provide the frame and timestamp to the receiving stack for Rx processing.

Using the disclosed method steps 61-66, the timing synchronization connector module allows two Ethernet time sync software stacks to interoperate together so that their respective functionality may be integrated and combined with accurate timing synchronization. This is especially useful with automotive systems that rely on a standardized time synchronization stacks that support time aware applications but do not perform other features, like bridging, that can be supported with a separate bridging time synchronization stack.

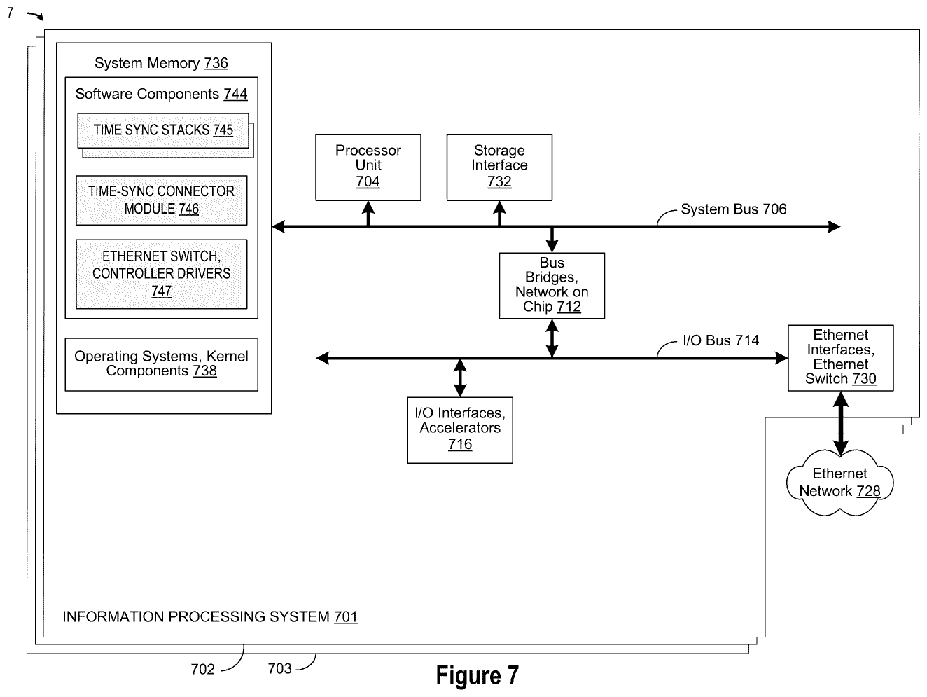

To provide additional details for an improved understanding of selected embodiments of the present disclosure, reference is now made to FIG. 7 which depicts a block diagram 7 of one or more information processing systems 701-703 capable of performing software-based timing synchronization of different Ethernet time synchronization stacks at a networked communication system. As disclosed herein, the timing synchronization functionality may be implemented primarily in software (including firmware, resident software, micro-code, etc.) or in embodiments combining software and hardware aspects that may all generally be referred to herein as a “circuit,” “module” or “system.” Certain implementations may incorporate all, fewer, or greater than the components described herein.

The depicted information processing system 701 may be implemented at an end station node, such as an electronic control unit (ECU), which includes one or more processor units 704 that are coupled to a system bus 706. Processor unit(s) 704 can have various architectures, such as a system on a chip (SOC), general-purpose processor, multiprocessor, custom compute accelerator, FPGA, hard-wired ASIC, etc. Though not shown, a user interface, such as a video adapter or the like, may be coupled between the system bus 706 and one or more peripheral devices (e.g., display). System bus 706 is coupled via one or more bus bridges or Network-on-Chip 712 to an Input/Output (I/O) bus 714. One or more I/O interfaces and/or accelerators 716 are coupled to the I/O bus 714 to provide communication with various I/O devices (not shown). For example, an I/O device may include a hardware timer, such as a free-running counter, one or more short and long range radar, camera and/or lidar sensors, and other suitable input devices. The format of the ports connected to I/O interface 716 may be any known to those skilled in the art of computer architecture, including but not limited to Universal Serial Bus (USB) ports. The information processing system 701 is able to communicate with an Ethernet Network 728 via one or more Ethernet Interfaces or Switches 730 which are coupled to the I/O bus 714.

A storage interface 732 is also coupled as an interface between a storage device (e.g., flash memory) and system bus 706 to populate a system memory 736, which is also coupled to system bus 706. Data that populates system memory 736 includes the operating systems and kernel components 738 and software components 744 for the information handling system 701. The OS 738 may include a shell (not shown) for providing transparent user access to resources such as software components 744. As depicted, each OS 738 may also include a kernel component in which lower levels of functionality for OS 738 are implemented, including essential services required by other parts of OS 738 and software components 744, including memory management, process and task management, and management of peripherals, such as network interfaces or user interface peripherals, accelerators, and memory storage.

The software programs 744 may include any number of applications executed by the information handling system 702. In accordance with selected embodiments of the present disclosure, the software programs 744 may include a plurality of time sync stacks 745, such as the standardized time sync stack 11 and bridging time sync stack 12 shown in FIG. 1. In addition, the software programs 744 may include a time-sync connector module 746 which is configured with program code to provide timing synchronization between the different time sync stacks 745. As disclosed, the time-sync connector module 746 may be configured to implement transmit and receive processing of Ethernet time sync frames which carry the virtual timestamp information to the corresponding time sync stacks 745.

The hardware elements depicted in the information processing system 701 are not intended to be exhaustive, but rather are representative to highlight components that can be implemented by the present disclosure. For instance, the information processing system 701 may include alternate memory storage devices. In addition, multiple information processing systems 701-703 may be connected in an Ethernet network wherein timing synchronization is required between different end station nodes or ECUs. These and other variations are intended to be within the spirit, scope and intent of the present disclosure.

By now it should be appreciated that there has been provided a computer-implemented method, architecture, circuit, and system for synchronizing timing between two different time synchronization stacks connected by a timing synchronization connector. In the disclosed methodology, a frame transmit request from a first time synchronization stack is received at a first virtual Ethernet controller of the timing synchronization connector that is connected to the first time synchronization stack. In selected embodiments, the frame transmit request is a request to transmit an Ethernet time synch frame. In other selected embodiments, the first time synchronization stack is a bridging time synchronization stack for implementing bridging of generalized Precision Time Protocol (gPTP) packets. The disclosed methodology also uses a virtual timestamp module of the timing synchronization connector to generate a sampled timestamp value for the frame transmit request by sampling a hardware counter. In addition, the disclosed methodology forwards the sampled timestamp value, along with the frame transmit request, to a second time synchronization stack using a second virtual Ethernet controller of the timing synchronization connector. In selected embodiments, the timing synchronization connector forwards the sampled timestamp value for the frame transmit request to the second time synchronization stack by storing the sampled timestamp value with the metadata for the frame transmit request being forwarded to the second time synchronization stack. In other selected embodiments, the second time synchronization stack is a time synchronization stack that does not implement bridging of generalized Precision Time Protocol (gPTP) packets. The disclosed methodology also sends the sampled timestamp value to the first time synchronization stack connected using the first virtual Ethernet controller of the timing synchronization connector. In selected embodiments, the timing synchronization connector sends the sampled timestamp value for the frame transmit request to the first time synchronization stack by storing the sampled timestamp value with the metadata for the frame transmit request being sent to the first time synchronization stack. As a result of receiving the sampled timestamp value for the frame transmit request, the first and second time synchronization stacks each use the sampled timestamp value to compute a time synchronized Precision Time Protocol (PTP) clock domain signal. In selected embodiments, the timing synchronization connector is connected and configured to provide read access to the hardware counter by the second time synchronization stack.

In another form, there has been provided a time synchronization device, method, circuit, and system for synchronizing timing between two different time synchronization stacks connected by a timing synchronization connector. In the disclosed device, there is provided one or more processor circuits and a hardware counter. The processor circuit is configured to execute a timing synchronization connector module by receiving, at a first virtual Ethernet controller of the timing synchronization connector module, a frame transmit request from a first time synchronization stack connected to the timing synchronization connector module. The processor circuit is also configured to execute a timing synchronization connector module by generating, at a virtual timestamp module of the timing synchronization connector module, a sampled timestamp value for the frame transmit request by sampling a hardware counter. In addition, the processor circuit is configured to execute a timing synchronization connector module by forwarding, over a second virtual Ethernet controller of the timing synchronization connector module, the sampled timestamp value for the frame transmit request along with the frame transmit request to a second time synchronization stack connected to the timing synchronization connector module. The processor circuit is also configured to execute a timing synchronization connector module by sending, over the first virtual Ethernet controller of the timing synchronization connector module, the sampled timestamp value for the frame transmit request to the first time synchronization stack connected to the timing synchronization connector module, where the first and second time synchronization stacks each use the sampled timestamp value to compute a time synchronized Precision Time Protocol (PTP) clock domain signal. In selected embodiments, the timing synchronization connector module executed by the processor circuit is configured to provide read access to the hardware counter by the second time synchronization stack. In other selected embodiments, the first time synchronization stack is a bridging time synchronization stack for implementing bridging of generalized Precision Time Protocol (gPTP) packets, and the second time synchronization stack is a time synchronization stack that does not implement bridging of gPTP packets. In other selected embodiments, the timing synchronization connector module executed by the processor circuit is configured to forward the sampled timestamp value for the frame transmit request to the second time synchronization stack by storing the sampled timestamp value with the metadata for the frame transmit request being forwarded to the second time synchronization stack. In other selected embodiments, the timing synchronization connector module executed by the processor circuit is configured to send the sampled timestamp value for the frame transmit request to the first time synchronization stack by storing the sampled timestamp value with the metadata for the frame transmit request being sent to the first time synchronization stack. In other selected embodiments, the timing synchronization connector module executed by the processor circuit is configured to provide read access to the hardware counter by the second time synchronization stack.

In another form, there has been provided a device, method, circuit, and system where a timing synchronization connector is connected between two different time synchronization stacks. The disclosed timing synchronization connector includes a first virtual Ethernet controller connected and configured to receive a frame transmit request from a first time synchronization stack connected to the timing synchronization connector. The disclosed timing synchronization connector also includes a virtual timestamper connected and configured to generate a sampled timestamp value for the frame transmit request by sampling a hardware counter. In addition, the disclosed timing synchronization connector includes a second virtual Ethernet controller connected and configured to forward the frame transmit request along with the sampled timestamp value for the frame transmit request to a second time synchronization stack connected to the timing synchronization connector. In the disclosed timing synchronization connector, the first virtual Ethernet controller is connected and configured to send the sampled timestamp value for the frame transmit request to the first time synchronization stack connected to the timing synchronization connector. In selected embodiments, the first and second time synchronization stacks each use the sampled timestamp value to compute a time synchronized Precision Time Protocol (PTP) clock domain signal. In other selected embodiments, the frame transmit request is a request to transmit an Ethernet time synch frame. In other selected embodiments, the first time synchronization stack is a bridging time synchronization stack for implementing bridging of generalized Precision Time Protocol (gPTP) packets, and the second time synchronization stack is a time synchronization stack that does not implement bridging of gPTP packets. In selected embodiments, the timing synchronization connector is configured to forward the sampled timestamp value for the frame transmit request to the second time synchronization stack by storing the sampled timestamp value with the metadata for the frame transmit request being forwarded to the second time synchronization stack. In other selected embodiments, the timing synchronization connector is configured to send the sampled timestamp value for the frame transmit request to the first time synchronization stack by storing the sampled timestamp value with the metadata for the frame transmit request being sent to the first time synchronization stack. In selected embodiments, the timing synchronization connector is configured to provide read access to the hardware counter by the second time synchronization stack.

Although the described exemplary embodiments disclosed herein focus on providing gPTP timing synchronization between standardized and bridging time synchronization stacks, the present disclosure is not necessarily limited to the example embodiments illustrate herein. For example, various embodiments of providing timing synchronization between different time sync stacks may be applied in any suitable data processing system application, and may use additional or fewer circuit components than those specifically set forth. Thus, the particular embodiments disclosed above are illustrative only and should not be taken as limitations upon the present invention, as the invention may be modified and practiced in different but equivalent manners apparent to those skilled in the art having the benefit of the teachings herein. Accordingly, the foregoing description is not intended to limit the invention to the particular form set forth, but on the contrary, is intended to cover such alternatives, modifications and equivalents as may be included within the spirit and scope of the invention as defined by the appended claims so that those skilled in the art should understand that they can make various changes, substitutions and alterations without departing from the spirit and scope of the invention in its broadest form.

Benefits, other advantages, and solutions to problems have been described above with regard to specific embodiments. However, the benefits, advantages, solutions to problems, and any element(s) that may cause any benefit, advantage, or solution to occur or become more pronounced are not to be construed as a critical, required, or essential feature or element of any or all the claims. As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

What is claimed is:

1. A computer-implemented method for synchronizing timing between two different time synchronization stacks connected by a timing synchronization connector, the method comprising:
receiving, at a first virtual Ethernet controller of the timing synchronization connector, a frame transmit request from a first time synchronization stack connected to the timing synchronization connector;
generating, at a virtual timestamp module of the timing synchronization connector, a sampled timestamp value for the frame transmit request by sampling a hardware counter;
forwarding, over a second virtual Ethernet controller of the timing synchronization connector, the sampled timestamp value for the frame transmit request along with the frame transmit request to a second time synchronization stack connected to the timing synchronization connector; and
sending, over the first virtual Ethernet controller of the timing synchronization connector, the sampled timestamp value for the frame transmit request to the first time synchronization stack connected to the timing synchronization connector,
where the first and second time synchronization stacks each use the sampled timestamp value to compute a time synchronized Precision Time Protocol (PTP) clock domain signal.

2. The computer-implemented method of claim 1, where the frame transmit request comprises a request to transmit an Ethernet time synch frame.

3. The computer-implemented method of claim 1, where the first time synchronization stack comprises a bridging time synchronization stack for implementing bridging of generalized Precision Time Protocol (gPTP) packets.

4. The computer-implemented method of claim 3, where the second time synchronization stack comprises a time synchronization stack that does not implement bridging of generalized Precision Time Protocol (gPTP) packets.

5. The computer-implemented method of claim 1, where the timing synchronization connector forwards the sampled timestamp value for the frame transmit request to the second time synchronization stack by storing the sampled timestamp value with the metadata for the frame transmit request being forwarded to the second time synchronization stack.

6. The computer-implemented method of claim 1, where the timing synchronization connector sends the sampled timestamp value for the frame transmit request to the first time synchronization stack by storing the sampled timestamp value with the metadata for the frame transmit request being sent to the first time synchronization stack.

7. The computer-implemented method of claim 1, where the timing synchronization connector is connected and configured to provide read access to the hardware counter by the second time synchronization stack.

8. A device, comprising:
at least one processor circuit configured to execute a timing synchronization connector module by:
receiving, at a first virtual Ethernet controller of the timing synchronization connector module, a frame transmit request from a first time synchronization stack connected to the timing synchronization connector module;
generating, at a virtual timestamp module of the timing synchronization connector module, a sampled timestamp value for the frame transmit request by sampling a hardware counter;
forwarding, over a second virtual Ethernet controller of the timing synchronization connector module, the sampled timestamp value for the frame transmit request along with the frame transmit request to a second time synchronization stack connected to the timing synchronization connector module; and
sending, over the first virtual Ethernet controller of the timing synchronization connector module, the sampled timestamp value for the frame transmit request to the first time synchronization stack connected to the timing synchronization connector module,
where the first and second time synchronization stacks each use the sampled timestamp value to compute a time synchronized Precision Time Protocol (PTP) clock domain signal.

9. The device of claim 8, where the timing synchronization connector module is configured to provide read access to the hardware counter by the second time synchronization stack.

10. The device of claim 8, where the first time synchronization stack comprises a bridging time synchronization stack for implementing bridging of generalized Precision Time Protocol (gPTP) packets, and where the second time synchronization stack comprises a time synchronization stack that does not implement bridging of gPTP packets.

11. The device of claim 8, where the timing synchronization connector module is configured to forward the sampled timestamp value for the frame transmit request to the second time synchronization stack by storing the sampled timestamp value with the metadata for the frame transmit request being forwarded to the second time synchronization stack.

12. The device of claim 8, where the timing synchronization connector module is configured to send the sampled timestamp value for the frame transmit request to the first time synchronization stack by storing the sampled timestamp value with the metadata for the frame transmit request being sent to the first time synchronization stack.

13. The device of claim 8, where the timing synchronization connector module is configured to provide read access to the hardware counter by the second time synchronization stack.

14. A timing synchronization connector connected between two different time synchronization stacks, comprising:
a first virtual Ethernet controller connected and configured to receive a frame transmit request from a first time synchronization stack connected to the timing synchronization connector;
a virtual timestamper connected and configured to generate a sampled timestamp value for the frame transmit request by sampling a hardware counter; and
a second virtual Ethernet controller connected and configured to forward the frame transmit request along with the sampled timestamp value for the frame transmit request to a second time synchronization stack connected to the timing synchronization connector;
where the first virtual Ethernet controller is connected and configured to send the sampled timestamp value for the frame transmit request to the first time synchronization stack connected to the timing synchronization connector.

15. The timing synchronization connector of claim 14, where the first and second time synchronization stacks each use the sampled timestamp value to compute a time synchronized Precision Time Protocol (PTP) clock domain signal.

16. The timing synchronization connector of claim 14, where the frame transmit request comprises a request to transmit an Ethernet time synch frame.

17. The timing synchronization connector of claim 14, where the first time synchronization stack comprises a bridging time synchronization stack for implementing bridging of generalized Precision Time Protocol (gPTP) packets, and where the second time synchronization stack comprises a time synchronization stack that does not implement bridging of gPTP packets.

18. The timing synchronization connector of claim 14, where the timing synchronization connector is configured to forward the sampled timestamp value for the frame transmit request to the second time synchronization stack by storing the sampled timestamp value with the metadata for the frame transmit request being forwarded to the second time synchronization stack.

19. The timing synchronization connector of claim 14, where the timing synchronization connector is configured to send the sampled timestamp value for the frame transmit request to the first time synchronization stack by storing the sampled timestamp value with the metadata for the frame transmit request being sent to the first time synchronization stack.

20. The timing synchronization connector of claim 14, where the timing synchronization connector is configured to provide read access to the hardware counter by the second time synchronization stack.
